(19) United States
(12) Patent Application Publication
(10) Pub. No.: US 2025/0181634 A1
(43) Pub. Date: Jun. 5, 2025

(54) IMAGE RETRIEVAL APPARATUS

(71) Applicant: Mitsubishi Electric Corporation, Tokyo (JP)

(72) Inventor: Teng-Yok LEE, Tokyo (JP)

(73) Assignee: Mitsubishi Electric Corporation, Tokyo (JP)

(21) Appl. No.: 19/046,620

(22) Filed: Feb. 6, 2025

Related U.S. Application Data
(63) Continuation of application No. PCT/JP2022/038291, filed on Oct. 14, 2022.

(51) Int. Cl. G06F 16/56; G06V 10/50; G06V 10/52; G06V 10/62; G06V 10/77; G06V 10/82

(52) U.S. Cl. CPC G06F 16/56; G06V 10/50; G06V 10/52; G06V 10/62; G06V 10/7715; G06V 10/82

(57) ABSTRACT

The image retrieval apparatus according to the disclosed technology is Image retrieval apparatus including, Feature reduction processing circuit, and Retrieval processing unit. Matrix calculator, included in the Feature reduction processing circuit, calculates matrix based on a stored data. Projection transforming portion, included in the Feature reduction processing circuit, multiplies the matrix to an image feature quantity acquired sequentially. Second projection transforming portion, included in the Retrieval processing unit, calculates low-dimensionalized image feature from the inputted image feature of the search target with the matrix. Search executing portion, included in the Retrieval processing unit, calculates distances between vectors calculated by the Projection transforming portion and the low-dimensionalized image feature in feature space, and performs search for plausible image features by using the distances. The vectors calculated by the Projection transforming portion belongs to a time-window-divided database.

### CROSS REFERENCE TO RELATED APPLICATION

This application is a Continuation of PCT International Application No. PCT/JP2022/038291, filed on Oct. 14, 2022, which is hereby expressly incorporated by reference into the present application.

### TECHNICAL FIELD

The present disclosure relates to Image retrieval apparatus.

### BACKGROUND ART

In the technical field of image search, in order to achieve high-speed search, reducing the dimensionality of image feature quantity using a matrix obtained from the statistical analysis is known. Here, the statistical analysis refers to principal component analysis and discriminant analysis, for example. Also, here, the image feature quantity is a concept used in the technical field of machine learning and is a vector in the feature space generated from the image. An image feature, as the name implies, represents the characteristics of an image.

For example, Patent Document 1 discloses a technique for facilitating classification problems by converting the image features by the first linear conversion parameter, wherein, the first linear conversion parameter is a matrix obtained from the result of statistical analysis.

### CITATION LIST

### Patent Literature

[PTL 1]
WO 2014/167880 A1

### SUMMARY OF INVENTION

### Technical Problem

The image retrieval apparatus illustrated in Patent Document 1 can be applied as a system for finding lost children or suspicious persons from video images taken by security cameras in facilities such as airports. In this specification, a system for finding lost or suspicious persons from video images taken by security cameras at facilities such as airports is referred to as a “query system”.

The inventor of the disclosed technology found out that when applying the image retrieval apparatus exemplified in Patent Document 1 to the query system, the matrices suitable for use in dimensionality reduction gradually vary when viewed in a time window in units of one day, even though it is an image obtained from the same security camera.

An object of the disclosed technology is to provide Image retrieval apparatus that solve the problem that matrices suitable for use in dimensionality reduction are gradually changing.

### Solution to Problem

The image retrieval apparatus according to the disclosed technology is Image retrieval apparatus including, Feature reduction processing circuit, and Retrieval processing circuit. Matrix calculator, included in the Feature reduction processing circuit, calculates matrix (C_{d}) based on a stored data (X_{d-1}). Projection transforming circuit, included in the Feature reduction processing circuit, multiplies the matrix (C_{d}) to an image feature quantity {fᵢ}acquired sequentially.

Second projection transforming circuit, included in the Retrieval processing circuit, calculates low-dimensionalized image feature (g_{target_x}) from the inputted image feature (f_{target}) of the search target with the matrix (C_{d}).

Search executing circuit, included in the Retrieval processing circuit, calculates distances between vectors calculated by the Projection transforming circuit and the low-dimensionalized image feature (g_{target_x}) in feature space, and performs search for plausible image features by using the distances. The vectors calculated by the Projection transforming circuit belongs to a time-window-divided database.

### Advantageous Effects of Invention

Since the Image retrieval apparatus according to the disclosed technology has the above configuration, the problem of matrices suitable for use in dimensionality reduction gradually changing can be solved.

### BRIEF DESCRIPTION OF DRAWINGS

FIG. 1 is a block diagram showing the functional configuration of Feature reduction processing circuit 100 according to the disclosed technology.

FIG. 2 is a time chart showing process of Feature reduction processing circuit 100 according to the disclosed technology in a time series manner.

FIG. 3 is a block diagram showing the functional configuration of Retrieval processing unit 200.

### DESCRIPTION OF EMBODIMENTS

As described above, the image feature quantity, which is a premise of the disclosed technology, is a concept used in the technical field of machine learning and is a vector quantity in feature space generated for the image. The disclosed technology is not limited to the matter of, from what kind of learning model the image feature quantity is generated, or even how the image feature quantity is generated. However, the image feature is easily understood if it is considered to be an intermediate product of learning model such as CNN (Convolutional Neural Network). CNN is a type of artificial neural network that has been recognized as an effective means, especially in the field of image analysis technology.

### Embodiment 1

Image retrieval apparatus according to the disclosed technology includes Feature reduction processing circuit 100 and Retrieval processing unit 200.

Feature reduction processing circuit 100 is a processing circuit that acquires the image feature quantity and performs a feature reduction process such as dimension reduction.

Retrieval processing unit 200 is a processing circuit that performs a search for plausible image features from a database divided for each time span (hereinafter referred to as a “time window”) when the image feature to be searched is inputted.

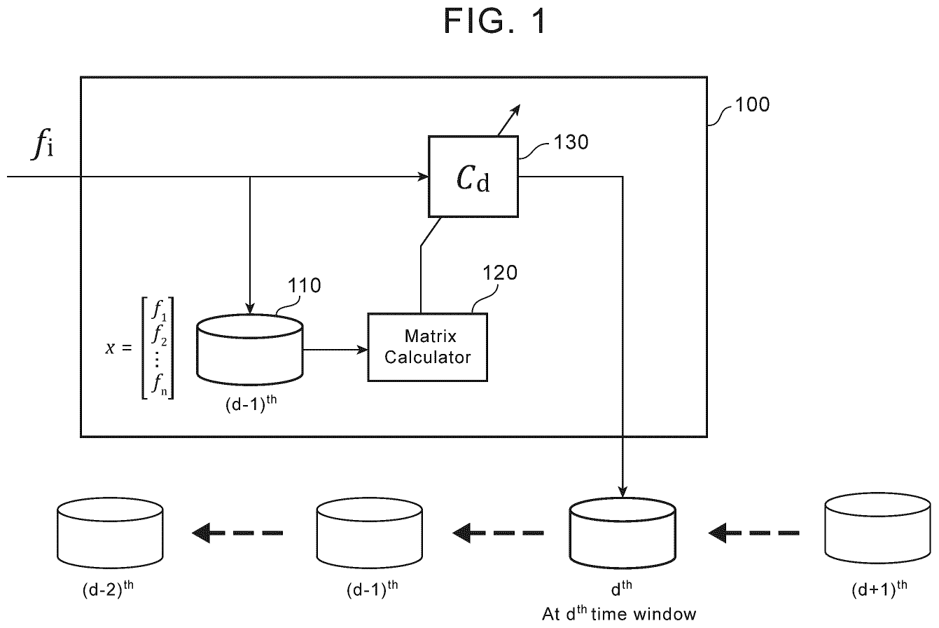

FIG. 1 is a block diagram showing the functional configuration of Feature reduction processing circuit 100 according to the disclosed technology. As shown in FIG. 1, Feature reduction processing circuit 100 includes Data storage unit 110, Matrix calculator 120, and Projection transforming portion 130.

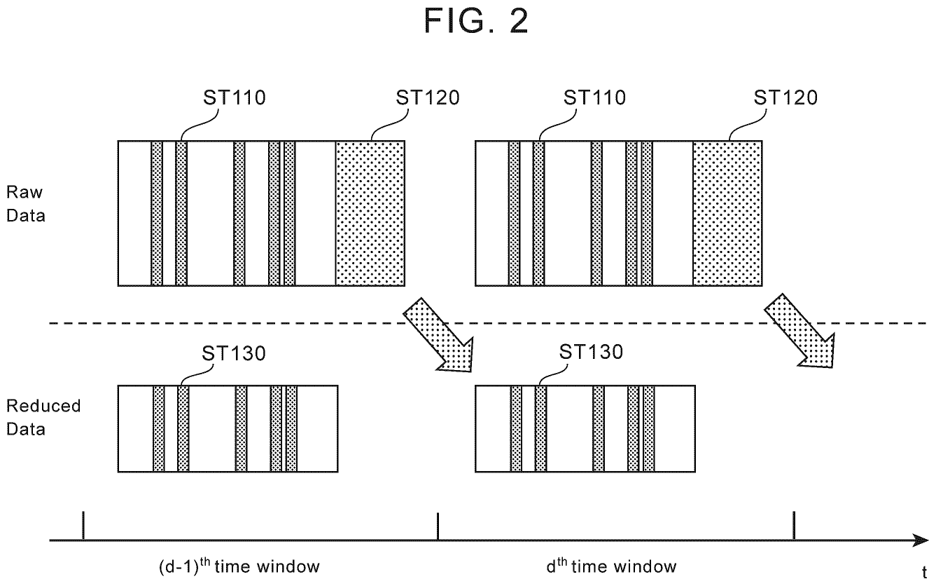

FIG. 2 is a time chart showing process of Feature reduction processing circuit 100 according to the disclosed technology in a time series manner. In FIG. 2, the portion indicated as ST110 represents the timing when processing by Data storage unit 110 is performed. Similarly, the portion indicated as ST120 indicates the timing when processing by Matrix calculator 120 is performed.

Also, similarly, the portion indicated as ST130 indicates the timing when processing by Projection transforming portion 130 is performed.

### (Data Storage Unit 110 Included in Feature Reduction Processing Circuit 100)

Data storage unit 110, included in Feature reduction processing circuit 100, is a component storing image features acquired sequentially as data. Assume that the image feature quantity to be acquired sequentially is expressed as {fᵢ}i=1, 2, . . . , m. The data (X) to be stored is given by the following equation,

$$X := [ \begin{matrix}{f}_{1} \\ {f}_{2} \\ ⋮ \\ {f}_{m}\end{matrix} ] \qquad ( 1 )$$

$$wherein ,$$

$$X ∈ {ℝ}^{m \times n}$$

As shown in Equation 1, the image feature quantity {fᵢ}acquired sequentially is a real vector having a size of 1×n. As used herein, the image feature quantity {fᵢ} is defined as a row vector. As shown in Equation 1, the image feature is generally a real vector with real numbers as components, but the definition can also be extended to complex vectors with complex numbers as components.

When the total number of image features quantity {fᵢ}sequentially acquired in a certain time window, for example, d-1st time window, is m, the data (X) stored in the data storage unit 110 is a matrix having a size of m×n. As shown in Equation 1, data (X) is generally a real matrix. But when the definition of the image features quantity {fᵢ} is extended to complex vector, data (X) becomes to a complex matrix.

As used herein, when emphasizing that the data (X) is a data according to the (d-1)^{th} time window, “d-1” is added in the form of a lower right subscript and is denoted by “X_{d-1}”. Also, hereinafter, the database composed of data belonging to the d^{th} time window is referred to as the “d^{th} database”.

### (Matrix Calculator 120 Included in Feature Reduction Processing Circuit 100)

Matrix calculator 120, included in Feature reduction processing circuit 100, is a component calculating matrix (C_{d}) for reducing the feature quantities based on data (X_{d-1}) of (d-1)^{th} time window. As shown in FIG. 2, the matrix (C_{d}) calculated by Matrix calculator 120 is used for arithmetic processing to sequentially reduce the feature amount of the image features quantity {fᵢ}acquired at a time belonging to the d^{th} time window. An important technical feature of the Image retrieval apparatus according to the disclosed technology is that C_{d}, the matrix used for arithmetic processing related to the d^{th} time window, is calculated based on the data (X_{d-1}) related to the d-1st time window. Note that the letter “C” used in “C_{d}” expressing the matrix to reduce the feature quantity comes from the acronym of “Compression”.

The matrix (C_{d}) calculated by Matrix calculator 120 may be, for example, a matrix obtained from the results of statistical analysis such as principal component analysis and discriminant analysis, as shown in Patent Document 1. The matrix (C_{d}) calculated by Matrix calculator 120 may be, specifically, a matrix obtained based on singular value decomposition (hereinafter, singular value decomposition is referred to as “SVC”). Assume that the SVC of the data (X_{d-1}) pertaining to the (d-1)^{th} time window is given as shown in the following equation.

$${X}_{d - 1} = U {\overbrace{[ \begin{matrix}{σ}_{1} & & \\ & ⋱ & \\ & & {σ}_{r}\end{matrix} ]}}^{S} {V}^{T} \qquad ( 2 )$$

$$wherein {σ}_{1} \geq {σ}_{2} \geq … \geq {σ}_{r} > 0$$

“U” appearing in Equation 2 is a matrix composed by the left singular vectors {uᵢ}, i=1, 2, . . . , r. Also, “V” appearing in Equation 2 is a matrix composed by the right singular vectors {vi}, i=1, 2, . . . , r. “T” in the upper right subscript represents the transpose operation. “S” appearing in Equation 2 is a diagonal matrix in which singular values are arranged in order of magnitude. “m” is the total number of rows of data (X_{d-1}) pertaining to the (d-1)^{th} time window and is the total number of acquired image feature quantities {fᵢ}. “n” is the total number of columns of data (X_{d-1}) pertaining to the (d-1)^{th} time window and is the number of elements in each image feature quantity {fᵢ}. It is assumed that “m” is larger than “n”. The “r” in the lower right subscript in Equation 2 is an acronym of “rank”, which represents the rank of X_{d-1}. If X_{d-1} is a column full rank, then “r” is equal to “n”. The fact that the rank of X_{d-1} is “r” is equivalent to the fact that the dimension of the space spanned by the vectors {fᵢ}, i=1, 2, . . . , m is “r”.

The matrices U and V composed of singular vectors have the following properties.

$${U}^{T} U = I ( r ) \qquad ( 3 )$$

$${V}^{T} V = I ( r )$$

I(r) appearing on the right-hand side of Equation 3 is an identity matrix having a size of r×r.

If X_{d-1} is not a zero matrix, the general inverse matrix of X_{d-1} can be defined using the result of Singular Value Decomposition (hereinafter simply referred to as “SVD”) shown in Equation 2 and the properties shown in Equation 3. According to the definition of the general inverse of the Moore-Penrose type, the general inverse matrix of X_{d-1} is given by the following equation.

$${X}_{d - 1}^{-} := V {\overbrace{[ \begin{matrix}1 / {σ}_{1} & & \\ & ⋱ & \\ & & 1 / {σ}_{r}\end{matrix} ]}}^{{S}^{- 1}} {U}^{T} \qquad ( 4 )$$

If X_{d-1} is a regular matrix, then the general inverse matrix given by Equation 4 is equivalent to the inverse matrix of X_{d-1}.

The subspace of Rn spanned by the row vectors {fᵢ}, i=1, 2, . . . , m is called the row domain of X_{d-1}. “Row domain” is sometimes referred to as “row space”, but in this document, the name “row domain” will be used. The right singular vectors {vi}, i=1, 2, . . . , r transposed are the normal orthogonal basis of the row domain of X_{d-1}.

One aspect of the Image retrieval apparatus according to the disclosed technology applies a projection matrix which projects vectors to the row domain of X_{d-1} to the query system. The projection matrix (PV) is given by the following equation.

$${P}_{v} = {VV}^{T} \qquad ( 5 )$$

Pᵥ shown in Equation 5 is the projection matrix having a size of n×n and a rank r. Note that VV^{T} shown in Equation 5 is different from V^{T}V shown in Equation 3.

Hereinafter, multiplication from the right is referred to as “right-multiplication”. Assume that an image feature quantity of the image to be queried is given, namely “f_{target}”. By right-multiplying the projection matrix (Pᵥ), f_{target} can be projected to the row domain of X_{d-1}. In the query system, being able to limit the search range to the row domain of X_{d-1} can contribute to shortening the processing time. Note that the letter “P” representing the projection matrix comes from the acronym of “Projection”.

By right-multiplying V to each side of the equation, and by applying the properties shown in Equation 3, Equation 2 can be deformed as the following equation.

$$[ \begin{matrix}{f}_{1} \\ {f}_{2} \\ ⋮ \\ {f}_{m}\end{matrix} ] V = U {\overbrace{[ \begin{matrix}{σ}_{1} & & \\ & ⋱ & \\ & & {σ}_{r}\end{matrix} ]}}^{S} {V}^{T} V = [ \begin{matrix}{u}_{1} , & … , & {u}_{r}\end{matrix} ] {\overbrace{[ \begin{matrix}{σ}_{1} & & \\ & ⋱ & \\ & & {σ}_{r}\end{matrix} ]}}^{S} \text{=:} [ \begin{matrix}\begin{matrix}\begin{matrix}{g}_{1} \\ {g}_{2}\end{matrix} \\ ⋮\end{matrix} \\ {g}_{m}\end{matrix} ] ∈ {ℝ}^{m \times r} \qquad ( 6 )$$

Here, {gᵢ}, i=1, 2, . . . , m is an image feature quantity where the dimension has been lowered (hereinafter referred to as “low-dimensionalized image feature”).

The following facts can be derived from Equation 6. If a certain row vector (fₓ) belongs to the row domain of X_{d-1}, i.e., fₓ can be expressed by a linear combination of {fᵢ}, i=1, 2, . . . , m, then the resulted vector obtained by right-multiplying “V” to the row vector (fₓ) can be expressed by a linear combination of {gᵢ}, i=1, 2, . . . , m.

$$Given {f}_{x} = {a}_{1} {f}_{1} + {a}_{2} {f}_{2} + … + {a}_{m} {f}_{m} \qquad ( 7 )$$

$$Then ,$$

$${f}_{x} V = {a}_{1} {g}_{1} + {a}_{2} {g}_{2} + … + {a}_{m} {g}_{m}$$

Here, each {gᵢ}, i=1, 2, . . . , m is a row vector having a size of 1×r. Also, since fₓV is the linear combination of {gᵢ}, fₓV is a row vector having the size of 1×r. {aᵢ}, i=1, 2, . . . , m is a coefficient, respectively.

Assume another row vector f_{y} is given. Unlike fₓ, assume f_{y} does not belong to the row domain of X_{d-1}. For f_{y}, which is not belonging to the row domain, a projection to the row domain could be considered by right-multiplying the projection matrix (Pᵥ) given in Equation 5. Since the projected vector (f_{y}Pᵥ) belongs to the row domain, f_{y}Pᵥ could be restated as fₓ. The above process can be expressed as follows.

$$\begin{matrix}{\overbrace{{f}_{y} {P}_{v}}}^{= {f}_{x}} V = {f}_{y} V {\overbrace{{V}^{T} V}}^{= i} \\ = {f}_{y} V\end{matrix} \qquad ( 8 )$$

After all, even for f_{y} not belonging to the row domain, by right-multiplying only “V”, the resulted vector f_{y}V will always be expressible by the linear combination of {gᵢ}, i=1, 2, . . . , m (refer Equation 8).

As described above, the matrix (C_{d}) calculated by Matrix calculator 120 may be “V” which is the matrix composed of singular vectors. If X_{d-1} is column full rank and “r” is equal to “n”, multiplying “V” will not help in changing the size of the vector.

In such a case, a method of dimensionality reduction by an approximation in which a singular value near 0 is set to 0 is considered. Details of this method will be shown in Embodiment 2.

### (Projection Transforming Portion 130 Included in Feature Reduction Processing Circuit 100)

Projection transforming portion 130, included in Feature reduction processing circuit 100, is a component that multiplies matrix (C_{d}) to the image feature quantity {fᵢ}acquired sequentially. C_{d} is the matrix calculated by Matrix calculator 120. As used herein, each of the image feature quantity {fᵢ} is defined as a row vector. Therefore, the multiplication of the matrix (C_{d}) is a right-multiplication to the image feature quantity {fᵢ}resulting fᵢC_{d}. Considering C_{d} as “V”, the size of C_{d} is n×r(r<n). Thus, Projection transforming portion 130 is a component that converts the image feature quantity {fᵢ}into a low-dimensionalized image feature {gᵢ}.

Although the low-dimensionalized image feature {gᵢ} in Equation 6 is calculated with “V”, the disclosed technology is not limited thereto. As used herein, any low-dimensionalized image feature calculated by Projection transforming portion 130, which may be a result of multiplication by a matrix (C_{d}) different from “V”, is referred to as {gᵢ}.

As shown in FIG. 1, the low-dimensionalized image feature {gᵢ}generated by Projection transforming portion 130 is stored in a storage device. The Image retrieval apparatus is accessible to the storage device. The low-dimensionalized image feature {gᵢ} is stored as a database for each time window. The matrix (C_{d}) used by Projection transforming portion 130 for multiplication is also used in Retrieval processing unit 200 of the Image retrieval apparatus. Therefore, the matrix (C_{d}) is shared between Feature reduction processing circuit 100 and Retrieval processing unit 200.

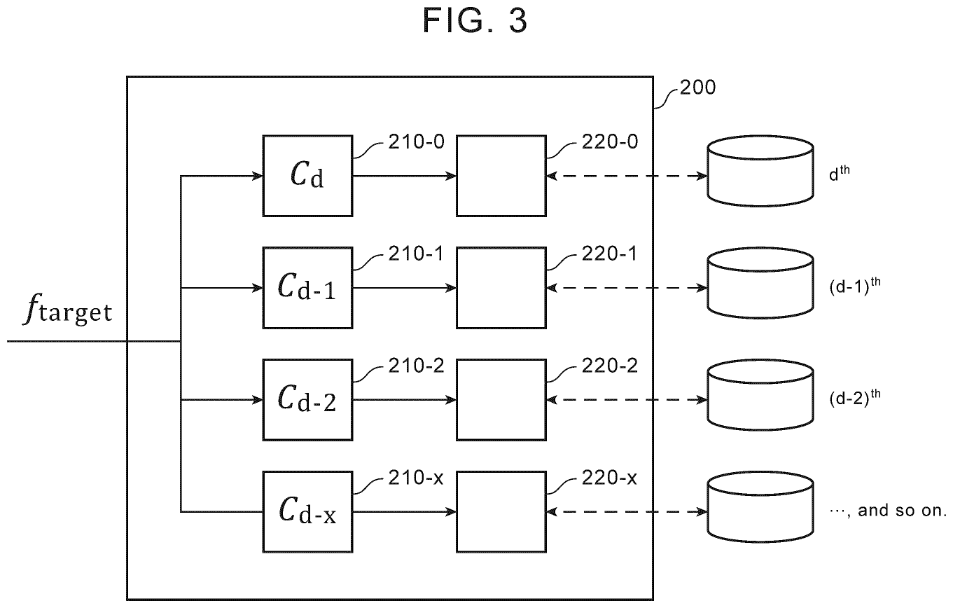

FIG. 3 is a block diagram showing the functional configuration of Retrieval processing unit 200. Feature reduction processing circuit 100 of the Image retrieval apparatus is a component used in the phase of accumulating image data. In contrast, Retrieval processing unit 200 of the Image retrieval apparatus is a component used in the image search phase. In explaining the processing contents of the Image retrieval apparatus according to the disclosed technology, the process is separately defined as “phase of accumulating image data” and “phase of searching for images”. However, in situations where Image retrieval apparatus is put into practical use, both phases can proceed simultaneously. That is, the image may be retrieved by Retrieval processing unit 200 in parallel with the accumulation of image data by Feature reduction processing circuit 100.

The “f_{target}” shown in FIG. 3 represents the image feature quantity of the image to be searched. If the Image retrieval apparatus is a query system, “f_{target}” is the image feature for the image being queried.

As shown in FIG. 3, Retrieval processing unit 200 includes Second projection transforming portion 210 (210-0, 210-1, . . . , 210-x, . . . ) and Search executing portion 220 (220-0, 220-1, . . . , 220-x, . . . ). As shown in FIG. 3, the function block having reference with “−0” attached at the end is a function block that handles a database pertaining to the d^{th} time window. Similarly, the function block having reference with “−1” attached at the end is a function block that handles a database pertaining to the (d-1)^{th} time window. In addition, as a generalized expression, the function block having reference with “-x” attached at the end is a function block that handles a database pertaining to the (d-x)^{th} time window. How many databases Retrieval processing unit 200 will search is a design matter of the Image retrieval apparatus. This matter may be determined based on the intended use and specifications of the Image retrieval apparatus.

### (Second Projection Transforming Portion 210 Included in Retrieval Processing Unit 200)

Second projection transforming portion 210, included in Retrieval processing unit 200, is a component calculating the low-dimensionalized image feature for the input f_{target}. It can be said that Second projection transforming portion 210 corresponds to Projection transforming portion 130 of Feature reduction processing circuit 100. As mentioned above, the matrices used by the Projection transforming portion 130 for multiplication (C_{d}, C_{d-1}, C_{d-2}, . . . , C_{d-x}, . . . ) are shared with Second projection transforming portion 210 of Retrieval processing unit 200.

The low-dimensionalized image feature (g_{target_x}) calculated in Second projection transforming portion 210 is given by the following equation.

$$for each x \qquad ( 9 )$$

$${g}_{target \_ x} := {f}_{target} {C}_{d - x}$$

When the matrix (C_{d-x}) used by Projection transforming portion 130 for multiplication is “V”, the matrix (C_{d-x}) used by Second projection transforming portion 210 for multiplication is also “V”.

### (Search Executing Portion 220 Included in Retrieval Processing Unit 200)

Search executing portion 220, included in Retrieval processing unit 200, is a component searching for plausible image features from the databases of different time window based on the low-dimensionalized image feature (g_{target_x}) calculated in Second projection transforming portion 210. The term “search” used herein is the same as that used in the field of computer technology and refers to a process of retrieving desired data or determining the location where it is stored.

Specifically, Search executing portion 220 calculates a distance in feature space and extracts a plausible image feature based on the magnitude of the calculated distance. The distance by which Search executing portion 220 calculates is a distance used as an index to evaluate similarity, such as Euclidean distance, Mahalanobis distance, Bhattacharyya distance, and the like.

As shown in Equations 2 and 6, when SVC arranged in order of increasing singularity values is used, the low-dimensionalized image feature (g_{target_x}) is generated so that the most major element is the first component, and the next major element is the second component (the same applies hereinafter). Thus, Search executing portion 220 may calculate distances and extract candidates for plausible image features, for example, by using only the first component or by using only the first k components (k is a natural number greater than 1 and less than r). Alternatively, Search executing portion 220 may, for example, calculate the distance using only the first component or only the first k components, and perform filtering that separates those that should be included for the search and those that should not be included for the search.

The idea of calculating the distance using only the first k components is common to the method of low-dimensionalization, which is an approximation in SVD form by replacing the singular value near 0 to 0. As previously described, a method of dimensionality reduction by an approximation in which a singular value near 0 is set to 0 will be shown in Embodiment 2.

The search performed by Search executing portion 220 is achieved by calculating the distance between the low-dimensionalized image feature (g_{target_x}) of the search target and the low-dimensionalized image feature {gᵢ}saved as the database. Note that it is not necessary to know the distance for all of the low-dimensionalized image feature {gᵢ}.

The value of each component of the low-dimensionalized image feature (g_{target_x}) to be searched and the value of each component of the low-dimensionalized image feature {gᵢ} of database may be expressed in binary numbers. Binary notation helps narrow down the candidates for search (narrowing down the candidates is referred to as “filtering”). Specifically, the search performed by Search executing portion 220 checks whether or not the two data represented in binary numbers match, starting with the high-order bits. When comparing the first component of the low-dimensionalized image feature (g_{target_x}) to be searched and the first component of a certain low-dimensionalized image feature {gᵢ}being focused on, if the most upper bits of each do not match, it is unlikely that this pair has the shortest distance. In this way, data that the most upper bits of each do not match may be excluded from the search candidates. After filtering by the most upper bit, similar filtering by the second upper bit is performed. This search method is similar in concept to the search method called the dichotomy.

Note that the method mentioned above is not limited to binary numbers. A method of checking whether or not two data expressed in the general N-Positional notation match in order from the upper digits can also be considered as filtering in the search.

As described previously, the process of retrieving by Retrieval processing unit 200 may be executed in parallel with the accumulation of image data by Feature reduction processing circuit 100. For example, if the current time belongs to the d^{th} time window, Search executing portion 220 may perform a search of the d^{th} database in parallel with the image data accumulated in the d^{th} database by Feature reduction processing circuit 100. As shown in FIG. 2, the process ST120 in the dth time window can be executed only after all of the process ST110 in the dth time window has finished. Here, ST110 is the process of Data storage unit 110, and ST120 is the process of Matrix calculator 120. Therefore, according to the conventional concept, the Image retrieval apparatus cannot perform projection transformation processing (ST130) by Projection transforming portion 130 unless Data storage unit 110 has completed all the processing (ST110) of acquiring the image feature. That is, according to the conventional way of thinking, it is not possible to perform a search to the d^{th} time window database in parallel with the accumulation of the image data in the d^{th} time window.

Using a fixed matrix (C) to generate a low-dimensionalized image feature may be conceivable. However, as mentioned previously, the matrices suitable for use in dimensionality reduction gradually vary when viewed in a time window in units of one day, even though it is an image obtained from the same security camera. That is, as time passes, low-dimensionalization by a fixed matrix (C) becomes more and more unsuitable for query systems.

One of the excellent effects of the Image retrieval apparatus according to Embodiment 1 is that Projection transforming portion 130 can sequentially perform projection transformation processing (ST130) even before Data storage unit 110 completes all of the processing (ST110) of acquiring image features.

Another excellent effect of the Image retrieval apparatus according to Embodiment 1 is that Search executing portion 220 can perform a search of the d^{th} database in parallel with the image data accumulated in the d^{th} database by the feature reduction processing circuit 100.

In summary, the excellent effect of the Image retrieval apparatus according to Embodiment 1 is that it solves the problem of “the varying of matrices suitable for dimensionality reduction” and can perform high-speed searches targeting multiple databases related to different time windows.

These effects are obtained by actively exploiting the property that, for example, when a time window of one day unit is set, the change in the matrix suitable for use in dimensionality reduction is gradual.

Focusing on the property that the change is gradual, the Image retrieval apparatus according to Embodiment 1 uses the matrix C_{d} for projection at the d^{th} time window, where C_{d} is the calculated result based on the data (X_{d-1}) related to the (d-1)^{th} time window.

Due to this technical feature, the Image retrieval apparatus according to Embodiment 1 exhibits the excellent effects described above.

### Embodiment 2

An Image retrieval apparatus according to Embodiment 2 is a modification of the Image retrieval apparatus according to the disclosed technology. The Image retrieval apparatus according to Embodiment 2 is the same as the Image retrieval apparatus according to Embodiment 1 in terms of functional configuration. Therefore, unless otherwise specified, in Embodiment 2, the same reference numerals are used as in Embodiment 1.

It can be said that the Image retrieval apparatus according to Embodiment 2 is an embodiment that embodies a matrix calculated by Matrix calculator 120. The matrix calculated by Matrix calculator 120 according to Embodiment 2 is based on an approximation in SVD form. The approximation in SVD form is an approximation replacing the singular value near 0 to 0.

The SVD shown in Equation 2 can be approximated given by the following equation.

$$U {\overbrace{[ \begin{matrix}{σ}_{1} & & & & & \\ & ⋱ & & & & \\ & & {σ}_{k} & & & \\ & & & {σ}_{k + 1} & & \\ & & & & ⋱ & \\ & & & & & {σ}_{r}\end{matrix} ]}}^{S} {V}^{T} ≅ U {\overbrace{[ \begin{matrix}{σ}_{1} & & & & & \\ & ⋱ & & & & \\ & & {σ}_{k} & & & \\ & & & 0 & & \\ & & & & ⋱ & \\ & & & & & 0\end{matrix} ]}}^{\tilde{S}} {V}^{T} \qquad ( 10 )$$

The right-hand side of Equation 10 is the result of replacing from the (k+1)^{th} to the r^{th} singular value by 0 (zero) respectively. Note that the singular values in “S” are arranged in order of magnitude.

The diagonal matrix on the right side of Equation 10 is represented by “S” with the accent mark of tilde on top. The accent mark of tilde represents that “S” with the accent mark of tilde is similar to the original “S” on the left side of equation 10. Equation 10 represents the approximation in the SVD form. As shown in Equation 10, “k” is a positive integer smaller than the rank “r”.

The right-hand side of Equation 10 can be deformed as shown by the following equation.

$$U {\overbrace{[ \begin{matrix}{σ}_{1} & & & & & \\ & ⋱ & & & & \\ & & {σ}_{k} & & & \\ & & & 0 & & \\ & & & & ⋱ & \\ & & & & & 0\end{matrix} ]}}^{\tilde{S}} {V}^{T} = {U}_{trunc} {\overbrace{[ \begin{matrix}{σ}_{1} & & \\ & ⋱ & \\ & & {σ}_{k}\end{matrix} ]}}^{{S}_{trunc}} {( {V}_{trunc} )}^{T} \qquad ( 11 )$$

Here, the “trunc” in the lower right subscript appearing on the right side of Equation 11 is derived from the word “truncation”. U_{trunc} is a matrix of size m×k. S_{trunc} is a diagonal matrix of size k×k. V_{trunc} is a matrix of size n×k.

In the Image retrieval apparatus according to Embodiment 2 uses V_{trunc} of Equation 11 as the matrix calculated by Matrix calculator 120. Thus, in the Image retrieval apparatus according to Embodiment 2, Projection transforming portion 130 and Second projection transforming portion 210 perform projections using V_{trunc} The effect of using V_{trunc} as projection is the same as the effect of using only the first k components of the low-dimensionalized image feature (g_{target_x}) to calculate the distance disclosed in Embodiment 1.

The effect particular to the Image retrieval apparatus according to Embodiment 2 is that even when X_{d-1} is column full rank and “r” is equal to “n”, the dimension of the image feature (f_{target}) related to the image to be searched can be reduced from n to k. By this action, the Image retrieval apparatus according to Embodiment 2 solves the problem in a way described in Embodiment 1. That is, the Image retrieval apparatus according to Embodiment 2 solves the problem of “the varying of matrices suitable for dimensionality reduction”, and can perform high-speed searches targeting multiple databases related to different time windows.

### Embodiment 3

An Image retrieval apparatus according to Embodiment 3 is a variation of the Image retrieval apparatus according to the disclosed technology.

Unless otherwise specified, the same reference numerals are used in Embodiment 3 as with the previously mentioned embodiments. In Embodiment 3, description overlapping with the previously described embodiment is omitted as appropriate.

As described above, the technical feature of the Image retrieval apparatus according to Embodiments 1 and 2 is that C_{d}, the matrix used for arithmetic processing related to the d^{th} time window, is calculated based on the data (X_{d-1}) related to the d-1st time window. Thus, in the Image retrieval apparatus according to Embodiments 1 and 2, data (X_{d-1}) related to the (d-1)^{th} time window, which is the adjacent most recent past time window, is used.

The Image retrieval apparatus according to Embodiment 3 generalizes the part “adjacent recent past” to “empirically a past in which the characteristics of the image data can be predicted to be similar”. In other words, when viewed in a daily time window, the adjacent recent past is a concrete example of “a past in which the characteristics of the image data can be predicted to be similar in experience.” Technically speaking, it is not essential that the image data is “adjacent to the immediate past”, but it is important that “empirically it can be predicted that the features of the image data will be similar”.

The database used by Image retrieval apparatus is not limited to a database where the time window is a unit of “one-day”. For example, it may be required to create a database in a time window in units of 6 hours, such as 0 to 6 o'clock, 6 to 12 o'clock, 12 o'clock to 18 o'clock, 18 to 24 o'clock. Assume that the current time is included in the time window of “12 o'clock to 18 o'clock”. At this time, if it is known from experience that the characteristics of the image data related to this time window are similar to those of “12 o'clock to 18 o'clock” of yesterday, the image retrieval apparatus according to Embodiment 3 may calculate C_{d} using the data “12 o'clock to 18 o'clock” of yesterday.

As shown in the above example, the characteristics of image data related to humans may change periodically according to human life behavior.

There are some typical periods at which the characteristics of the image data change, such as, units of one day, units of one week, and units of one year.

For example, the characteristics of the image data may differ between weekdays and weekends.

Assume the current time is included in the Sunday time window. At this time, if it is known from experience that the characteristics of the image data related to this time window are similar to those of last Sunday, the Image retrieval apparatus according to Embodiment 3 may calculate a C_{d} using the data related to last Sunday. This cycle of change in units of one week is also thought to be derived from human life behavior.

Also, for example, the characteristics of the image data may differ between summer and winter. Assume that the current time is included in the summer time window.

At this time, if it is known from experience that the characteristics of the image data related to this time window are similar to those of last summer, the Image retrieval apparatus according to Embodiment 3 may calculate C_{d} using the data related to last summer. This cycle of change in units of one year is also thought to be derived from differences in human life behavior, especially from clothing.

It is also possible that the characteristics of the image data are different between a day when a special event is present and a normal day. Special events include festivals, concerts by popular artists, international conferences, international sporting events, etc.

For example, the characteristics of the image data on Christmas Eve may be different from the image data on a normal day.

Assume the current time is included in the Christmas Eve time window. At this time, if it is known from experience that the features of the image data related to this time window are similar to those of last Christmas Eve, the Image retrieval apparatus according to Embodiment 3 may calculate C_{d} using the data related to last Christmas Eve. As shown in this example, changes at a particular day having special events also stem from human life behavior.

In this way, it can be said that the characteristics of image data related to humans are closely related to human life behavior. Human life behavior is also greatly affected by disasters such as wars, pandemics, and natural disasters.

For example, assume that the current time is included in the time window for Christmas Eve 2022. In consideration of the impact of the spread of the new coronavirus infection, the Image retrieval apparatus according to Embodiment 3 may calculate C_{d} using the data related to Christmas Eve of, not last year, but 2019 or 2018 before the spread of the new coronavirus infection.

The Image retrieval apparatus according to Embodiment 3 calculates the projection matrix (C_{d}) based on data related to a time window of “past in which the features of the image data can be predicted to be similar in experience”.

By generalizing the matters concerning the calculation of the projection matrix (C_{d}), the Image retrieval apparatus according to Embodiment 3 can perform a high-speed search targeting a plurality of databases related to different time windows in consideration of human life behavior.

### INDUSTRIAL APPLICABILITY

The disclosed technology can be applied, for example, as a system for finding lost or suspicious persons from video images taken by security cameras at facilities such as airports, and has industrial applicability.

### REFERENCE SIGNS LIST

100 Feature reduction processing circuit, 110 Data storage unit, 120 Matrix calculator, 130 Projection transforming portion, 200 Retrieval processing unit, 210 Second projection transforming portion, 220 Search executing portion.

1. Image retrieval apparatus comprising,
Feature reduction processing circuit, and
Retrieval processing circuit,
wherein,
Matrix calculator, included in the Feature reduction processing circuit, calculates matrix based on a stored data,
Projection transforming circuit, included in the Feature reduction processing circuit, multiplies the matrix to an image feature quantity acquired sequentially,
Second projection transforming circuit, included in the Retrieval processing circuit, calculates low-dimensionalized image feature from an inputted image feature of a search target with the matrix, Search executing circuit, included in the Retrieval processing circuit, calculates distances between vectors calculated by the Projection transforming circuit and the low-dimensionalized image feature in feature space, and performs search for plausible image features by using the distances, the vectors calculated by the Projection transforming circuit belonging to a time-window-divided database.

2. Image retrieval apparatus according to claim 1,
wherein,
the matrix is calculated by using Singular Value Decomposition of the data.

3. Image retrieval apparatus according to claim 1,
wherein,
the matrix is calculated by using approximated singular vectors of the data.

4. Image retrieval apparatus according to claim 1,
wherein,
the stored data relates to images taken in an adjacent most recent past time window.

5. Image retrieval apparatus as in according to claim 1,
wherein,
the stored data relates to images taken in past time windows that, empirically, can be predicted to have similar features of an image data.
